(19) United States
(12) Patent Application Publication
(10) Pub. No.: US 2008/0308223 A1
(43) Pub. Date: Dec. 18, 2008

(54) Electronic component and manufacturing method thereof

(75) Inventors: Natsuhiko Sakairi, Saitama (JP); Tomomi Koshikawa, Saitama (JP); Seiji Oda, Saitama (JP); Toshimasa Tsuda, Saitama (JP)

Correspondence Address: Edwards Angell Palmer & Dodge LLP, P.O. Box 55874, Boston, MA, 02205, US

(73) Assignee: NIHON DEMPA KOGYO CO., LTD., Tokyo (JP)

(21) Appl. No.: 12/156,227

(22) Filed: May 30, 2008

(30) Foreign Application Priority Data
Jun. 12, 2007 (JP) JP 2007-154622

(51) Int. Cl. B32B 37/00

(52) U.S. Cl. 156/275.5; 156/285

(57) ABSTRACT

It is possible to prevent defects arising when resin-sealing electronic components, caused by leakage defects, resin interfusion defects, or the like, and it is possible to easily resin-seal a number of electronic components all together. There is provided a method of manufacturing electronic components on which SAW chips are mounted by face down bonding on wiring electrodes formed on a main face of a collective substrate, comprising the steps of: placing a resin sheet on the main face of the collective substrate, on which the SAW chips have been mounted; accommodating the collective substrate, on which the SAW chips have been mounted, in a flexible and sealed bag, and then seal-closing the sealed bag; submerging the accommodating bag into a pressurized container filled with a liquid, and then sealing off the pressurized container; supplying a pressurizing fluid into the pressurized container, raising the pressure within the pressurized container, carrying out heat application to heat-cure the resin sheet, and thereby tightly adhering the resin sheet onto the main face side of the SAW chips and the collective substrate, on which the SAW chips have been mounted so as to resin-seal the collective substrate; taking out the sealed bag from the pressurized container; taking out the resin-sealed collective substrate, on which the SAW chips have been mounted, from the sealed bag; and cutting the resin-sealed collective substrate, which has been taken out, into individual pieces.

### BACKGROUND OF THE INVENTION

The present invention relates to a piezoelectric component and a manufacturing method thereof, such that in a method of manufacturing a SAW device in which a SAW chip is sealed by a resin after an electronic component such as a surface acoustic wave (SAW) chip has been mounted on a mounting substrate by face down bonding using bumps, it is possible to manufacture using a simple method, a large number of piezoelectric devices all together, while preventing defects in products caused by leakage defects, resin infiltration defects, or the like.

A surface acoustic wave device (SAW device) is mounted in a mobile phone and is configured with patterns of comb shaped electrodes (IDT electrodes), and connection pads or the like arranged on a piezoelectric substrate such as crystal piezoelectric substrate and lithium tantalite substrate, wherein surface acoustic waves are excited by applying a high frequency electric field to the IDT electrodes, and a filter characteristic is obtained by converting surface acoustic waves into a high frequency electric field with a piezoelectric effect. In this SAW device, a predetermined gap (hollow section) is required to be present around the comb shaped electrodes sections.

Therefore, conventionally, packaging is carried out such that: the SAW chip is die-bonded in a face-up state; and after electrically connecting it by wire bonding, a metallic cap is placed, and seam welding or soldering sealing is carried out to perform packaging.

Recently, in order to downsize the SAW device, a small sized package device is configured such that the SAW chip is flip-chip-bonded (face down bonded) on a wiring substrate using Au bumps or soldering bumps, and sealing is carried out with a resin or the like.

Furthermore, in order to reduce the size and height of the SAW device, there has been proposed a micro chip size package (CSP) device in which: a gap (hollow section) is formed in a comb-shaped electrode section; an entire piezoelectric wafer on the comb shaped electrode side is sealed while maintaining this gap; an external connection electrode is formed; and then the wafer is divided into individual devices by dicing.

The techniques related to SAW devices are respectively disclosed for example in Japanese Patent Publication No. 3702961, Japanese Unexamined Patent Publication No. 2001-176995, and Japanese Unexamined Patent Publication No. 2003-17979.

### CONVENTIONAL EXAMPLE 1

First, in Japanese Patent Publication No. 3702961 (Patent Document 1), as shown in FIG. 4(a), a SAW chip 115 comprises: a mount substrate 102 provided with an insulating substrate 103, external electrodes 104 for surface mounting disposed on the bottom section of the insulating substrate 103, and wiring patterns 105 that are disposed on the top section of the insulating substrate 103 and are electrically connected to the external electrodes 104; and connection pads 116 that are connected to a piezoelectric substrate 118, an IDT electrode 117 formed on one face of the piezoelectric substrate 118, and to the wiring patterns 105 via conductive bumps 110. The SAW chip 115 is flip-chip mounted on the mount substrate 102 in a face down condition, and a sealing resin 131A is coating-formed on the area including the outer face of the SAW chip 115 and the top face of the mount substrate 102, thereby configuring a surface mount type SAW device while forming a hollow section S in between the IDT electrode 117 and the mount substrate 102.

As shown in FIGS. 4(b) and (c), a SAW device manufacturing method of the conventional example 1 includes:

a flip-chip mounting step in which the wiring patterns 105 and the connection pads 116 are connected via the conductive bumps 110, thereby flip-chip mounting the SAW chip 115 on the mount substrate 102;

a laminating step in which a resin sheet 130 with an area larger than that of the top face of the SAW chip 115 is placed on the top face of the SAW chip 115 and while softening the resin sheet from one end to another end of the mount substrate 102, the resin sheet 130 is pressed with use of a pressure roller 151 and a lower side roller 152, thereby coating the outer face of the SAW chip with the resin while ensuring a hollow section S;

a press forming step in which by pressing and heating the SAW chip 115, the outer face of which has been laminate-coated with the resin sheet 130, the resin sheet 130 is softened while suppressing expansion of the gas within the hollow section S; and

a final curing step in which a SAW device 101 that has been subjected to the press forming step is heated at a temperature and for a period of time, to completely cure the resin.

### CONVENTIONAL EXAMPLE 2

Moreover, in the SAW device manufacturing method disclosed in Japanese Unexamined Patent Publication No. 2001-176995 (Patent Document 2), as shown in FIGS. 5(a) and (b), there is provided a first step in which each SAW chip 210 is mounted on a substrate 220 using a batch method. This substrate 220 has connection pads 211 and 212 on one face of the substrate 220, and has connection pads 201 and 202 on the face opposite to the above mentioned face. The pads 201 and 202 are used for connecting the out side of electric contact points 203 and 204 of the SAW chip 210 by flip-chip type attachment with use of first conductive through holes 213 and 214 and bumps 205 and 206.

Then in a second step, as shown in FIG. 5(b), a deformed film 240 is attached over the entire SAW chip 210. By sucking out air through a series of holes 250 formed in the substrate 220, this film 240 is made to conform to and seal the SAW chips 210.

### CONVENTIONAL EXAMPLE 3

Furthermore, in a SAW device manufacturing method disclosed in Japanese Unexamined Patent Publication No. 2003-17979 (Patent Document 3), as shown in FIGS. 6(a) and (b), after the area including the electrode side face and the opposite side face of a SAW chip 302 and the surface of a substrate 303 has been coated with a gel curable sheet 301, heat pressing is carried out so that a hollow section S between the SAW electrode face and the face on which a wiring pattern is formed, is maintained by the portion that separates them by the height of a bump 304, and so that the surface of a protective layer 305 is formed in a flat shape.

However, in the SAW manufacturing method shown in the above conventional example 1 to conventional example 3, when sealing the SAW chip with a resin sheet or the like, there is required a complex device configuration: to carry out lamination with use of a pair of processing rollers; to suction air through the holes formed in the substrate; or to seal by carrying out heat pressing. Furthermore, it is also necessary to separately resin-seal collective substrates one by one.

The problem to be solved by the present invention is that when manufacturing, by resin-sealing, electronic components having no defects such as leakage defects, resin interfusion defects or the like, it is not possible to process a number of chip-mounted collective substrates all together, and a new and expensive manufacturing facility is required.

### SUMMARY OF THE INVENTION

In order to solve the above problems, the present invention is to manufacture electronic components, wherein: electronic elements are mounted, by face down bonding, on wiring electrodes formed on the main face of a collective substrate; a resin sheet is placed on the main face of the collective substrate on which the electronic elements have been already mounted; after the collective substrate on which the electronic elements have been mounted has been accommodated within a flexible sealed bag, the sealed bag is seal-closed; after the accommodating bag is placed in a pressurized container filled with a liquid, the pressurized container is sealed; a pressurizing fluid is supplied into the pressurized container; while raising the pressure within the pressurized container, heat application is carried out to heat-soften and tightly adhere the resin sheet onto the main face side of the electronic elements and the collective substrate on which the electronic elements have been mounted so as to resin-seal the collective substrate; the sealed bag is taken out of the pressurized container; the resin-sealed collective substrate on which the electronic elements have been mounted is taken out of the sealed bag; and the resin-sealed collective substrate that has been taken out of the sealed bag is cut into individual pieces.

Moreover, in the present invention, the resin sheet is made of a heat curing type resin, and as a result of the pressurized container or the fluid accommodated within the pressurized container being heated by the heat application curing, the resin sheet is heat cured on the collective substrate on which the electronic elements have been mounted, while, within the pressurized container, the sealed bag is pressed against and kept being tightly adhered onto the collective substrate on which the electronic elements have been mounted.

Furthermore, in the present invention, the resin sheet is made of a light curing type resin and the sealed bag and the fluid accommodated within the pressurized container are made of materials that transmit a sufficient light wavelength for curing the light curing type resin material, and the resin sheet is heat cured by irradiating light of the above light wavelength.

It is possible to prevent defects arising when resin-sealing electronic components, caused by leakage defects, resin interfusion defects, or the like, and it is possible to easily resin-seal a number of electronic components all together.

The electronic component manufacturing method of the present invention may be widely used for manufacturing piezoelectric components that require precise resin sealing such as SAW devices, crystal oscillators, and piezoelectric membrane filters, and for manufacturing piezoelectric elements such as SAW elements, FBAR, and MEMS.

### BRIEF DESCRIPTION OF THE DRAWINGS

FIG. 1 is a vertical sectional view of an individually separated SAW device to be manufactured by a SAW device manufacturing method that is an embodiment of an electronic component manufacturing method of the present invention.

FIG. 2 is a conceptual drawing of the SAW device manufacturing method of the embodiment of the present invention.

FIG. 3 shows vertical section views of a pressurized container used in a resin sealing step that is part of the SAW device manufacturing method of the embodiment shown in FIG. 2, wherein FIG. 3(a) shows a state before the interior of the pressurized container is pressurized where sealed bags are fully open, and FIG. 3(b) shows a state after the interior of the pressurized container has been pressurized where the sealed bags have been shrunk to resin-seal the collective substrates therein.

FIG. 4 shows a vertical sectional view (FIG. 4(a)) of a SAW device of a conventional example 1, a vertical sectional view (FIG. 4(b)) for describing a heat roller lamination step in a manufacturing method, and a cross-sectional view (FIG. 4(b)).

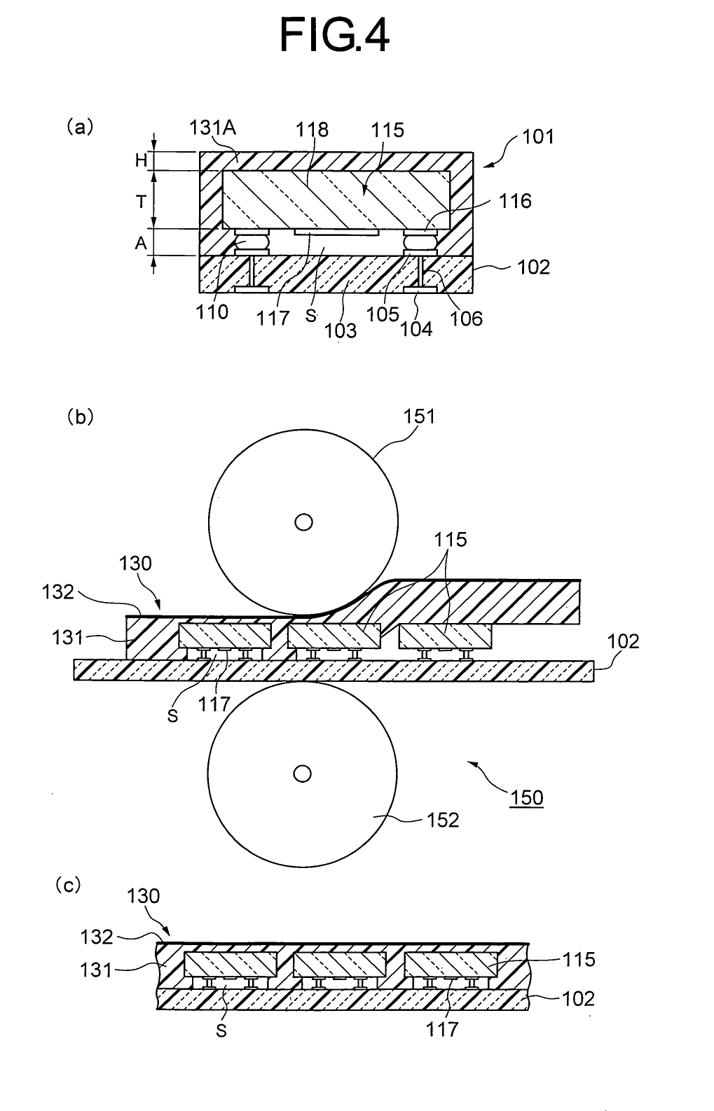

FIG. 5 is a drawing showing a manufacturing method of a conventional example 2, wherein FIG. 5(a) shows a vertical sectional view of a collective substrate prior to resin sealing, and FIG. 5(b) shows a vertical sectional view of the collective substrate after resin sealing.

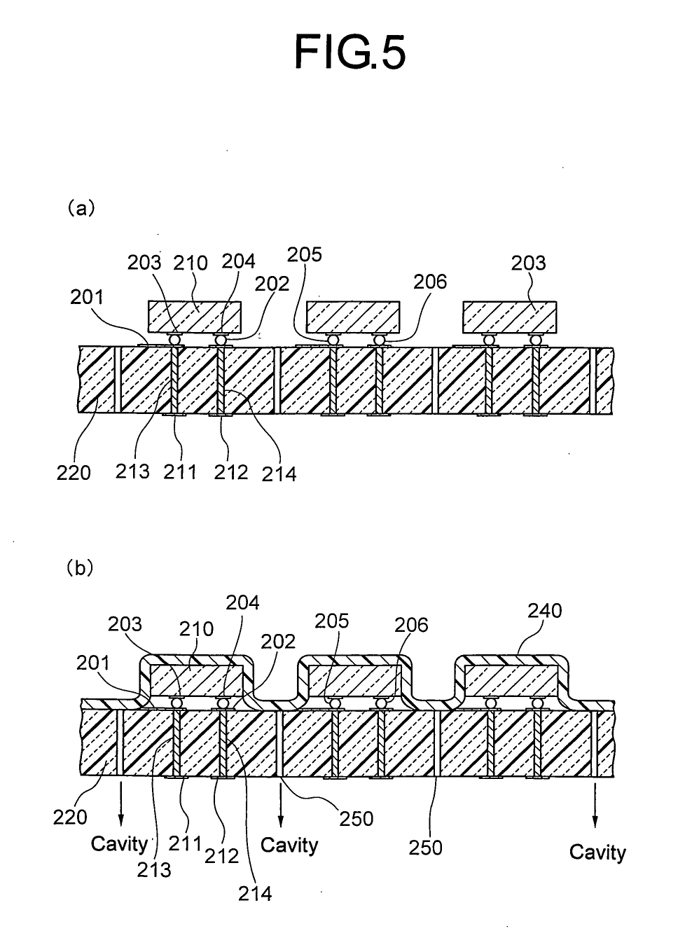

FIG. 6 is a drawing showing a manufacturing method of a conventional example 3, wherein FIG. 6(a) shows a vertical sectional view of a collective substrate prior to resin sealing, and FIG. 6(b) shows a vertical sectional view of the collective substrate after resin sealing.

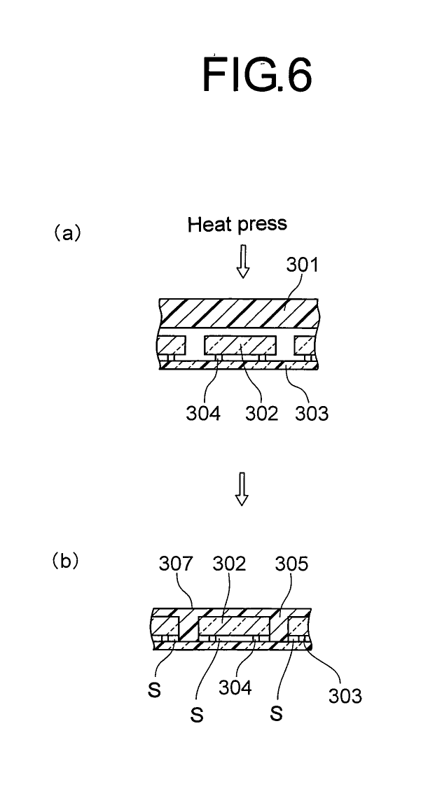

### DETAILED DESCRIPTION OF THE PREFERRED EMBODIMENT

Hereinafter, a manufacturing method of an electronic component of the present invention is described in detail for a manufacturing method of an embodiment of a mount type surface acoustic wave device (hereinafter, referred to as “SAW device”).

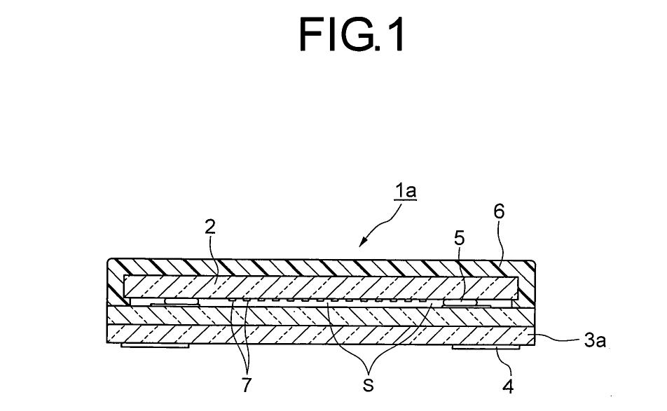

FIG. 1 shows a vertical sectional view of a SAW device la to be manufactured in a SAW device manufacturing method that is an embodiment of an electronic component manufacturing method of the present invention.

This SAW device 1a (piezoelectric component) comprises: a ceramic substrate (insulating substrate) 3a formed by laminating a plurality of ceramic; a SAW chip 2 that is formed from lithium tantalite (LiTaO₃) or the like for example and that is mounted on the top face of this ceramic substrate 3a via gold bumps 5; an epoxy resin (resin sealing section) 6 that resin-seals this SAW chip 2; and external electrodes 4 mounted on the bottom face of the ceramic substrate 3. The SAW chip 2 is sealed by for example an epoxy resin so as to form a hollow (cavity) section S between IDT electrodes 7 formed on the SAW chip 2, and the top face of the ceramic substrate 3.

Here, power feeding side lead terminals of the IDT electrodes 7 formed on the SAE chip 2 apply a high frequency electric field to excite surface acoustic waves, and the surface acoustic waves are converted into a high frequency electric field by a piezoelectric effect, thereby enabling filter characteristics to be achieved.

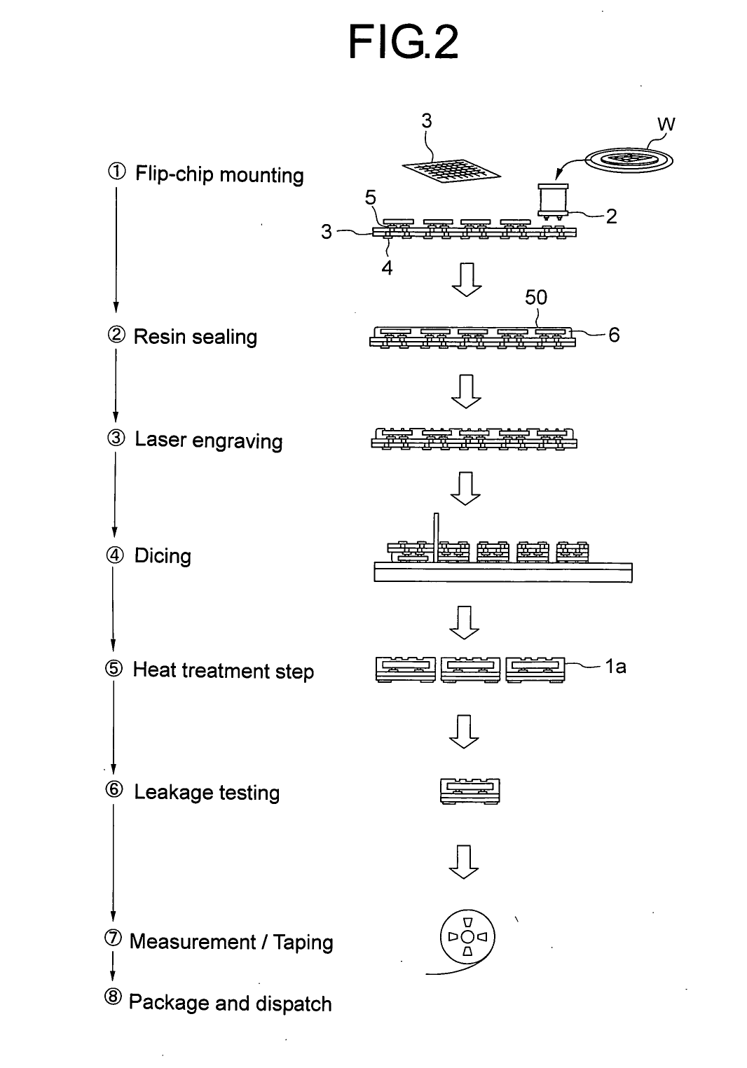

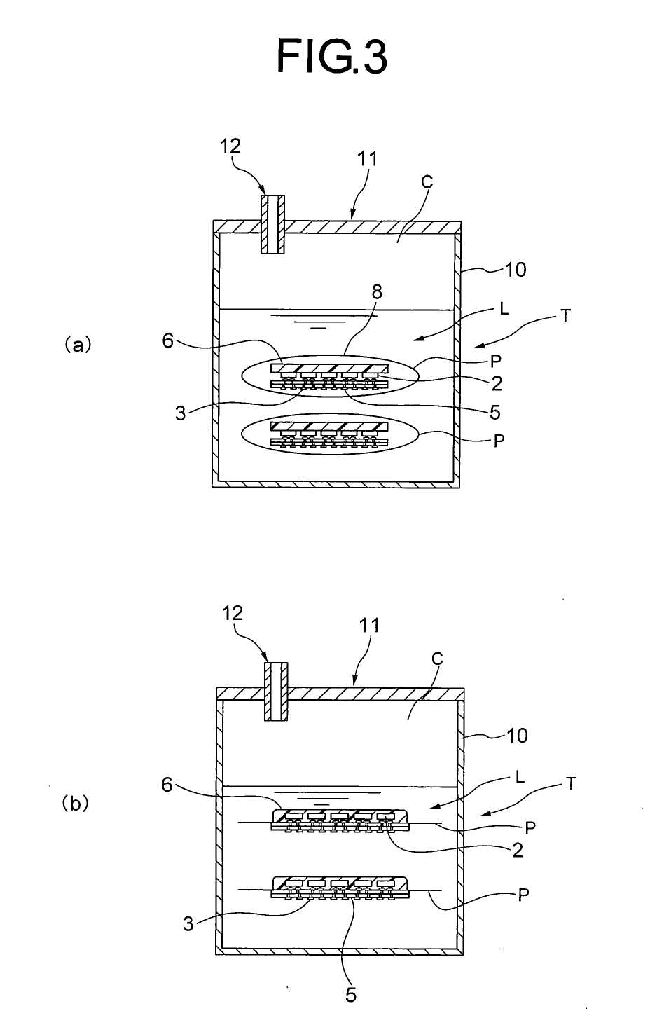

Next, the SAW device manufacturing method of the embodiment of the present invention is described, with reference to FIG. 2 and FIG. 3.

Manufacturing Method (Assembly Step)

FIG. 2 shows the SAW device manufacturing method (assembly step) of the embodiment of the present invention including; a flip switch mounting step, a resin sealing step, and a dicing step.

First, in order to manufacture the SAW device 1 shown in FIG. 1, as shown in FIG. 2, a mount (collective) substrate is fabricated in which the SAW chips (electronic elements) 2 having the gold bumps 5 and cut from a SAW wafer W are flip-chip mounted on wiring electrodes formed on the main face of a ceramic substrate (collective substrate) 3 using gold-gold ultrasonic thermocompression bonding ((i) flip-chip mounting step).

Next, having performed resin sealing on the mount substrate that has been flip-chip mounted in a sealing step described later, the resin is cured ((ii) resin sealing step).

Furthermore, a CO₂ gas laser is irradiated on the resin surface so as to engrave and mark a product number, a lot number, and the like thereon ((iii) laser marking step).

In the next step, based on an identification pattern formed on the back face of the mount substrate, the mount substrate is divided, using a dicing saw, into individual SAW devices in a dicing step described later ((iv) dicing step).

Furthermore, the SAW devices are subjected to: (v) a heat treatment step (at 150° C. for three hours); (vi) a leakage testing step; (vii) a step of measurement (whether or not frequency in accordance with the specification can be outputted)/taping (the divided SAW devices are integrated using an embossing tape), and then the SAW devices are (viii) packaged and dispatched.

The configuration of the SAW device manufacturing method of the embodiment of the present invention is characterized (summarized) particularly in the resin sealing step described in detail below.

Resin Sealing Step

First, the resin sealing step is described, with reference to FIG. 3.

As shown in FIG. 3, a pressurized container T is used in this resin sealing step. This pressurized container T comprises a container main body 10 and a lid body 11 in which there is a pressurizing fluid supply hole 12. A predetermined liquid (this may be a gaseous body) L is accommodated within the container main body 10 so as to form a predetermined space C, and the collective substrates 3 to be resin-sealed that are accommodated within a sealed bag are submerged in the liquid L.

FIG. 3(a) shows a state before the pressurized container T is pressurized, and FIG. 3(b) shows a state where the pressurized container T has been pressurized and each of the collective substrates 3 has been resin-sealed with a resin sheet (including a resin film).

Here, the resin sheet that may be used in the present invention includes for example epoxy resin. Compared to liquid resins, this epoxy resin has a much higher viscosity, and the softened resin sheet thereof has a viscosity of 7,000 to 20,000 Pa·s. The resin sheet is in a gel state and has no fluidity in this state, and therefore resin interfusion into a narrow gap section, which is generally caused by a capillary phenomenon in the liquid state, does not occur. Consequently, when the pressing pressure is stopped, the resin sheet does not continue to further deform itself. Here, the preferable heat treatment temperature for softening the resin sheet is 30° C. to 150° C., and is more preferably 80° C. to 100° C.

First, in order to resin-seal the collective substrate 3 in the present resin-sealing step, the collective substrate 3 having the SAW chips 2 and the bumps 5 mounted thereon, and with a resin sheet 6 with a predetermined thickness (for example, 0.25 mm) appropriately and temporarily fixed on the top face of the SAW chips, is placed and sealed into a PET (polyethylene terephthalate) polyethylene reclosable bag (sealed bag) 7 (for example, commercially available percoll reclosable bag) with a thickness of approximately 50 μm. When accommodating the collective substrate 3 having the SAW chips already mounted thereon into the sealed bag P, sealing may be performed after the inside of the sealed bag P has been depressurized and degassed. Here, in order to carry out flat resin-sealing, a flat plate 8 made of a material (for example, aluminum) harder than the resin sheet 6 may be placed on the resin sheet 6. Moreover, the number of sealed bags P for accommodating and sealing the collective substrates 3 therein is determined according to the number that allows accommodation of the collective substrates 3 in the pressurized container T.

Thus, the sealed bag P that seals a number of the collective substrates 3 therein all together is submerged in the liquid L accommodated in the pressurized container T.

Having submerged the sealed bags: the lid body 11 is placed over the container main body 10 so as to seal off the interior of the pressurized container T; a pressurizing gas (maximum 6 atmospheres pressure, preferably maximum 5 atmospheres pressure) is supplied though the hole 12 provided in the lid body 11 while the pressure of the pressurizing is controlled; and the pressurized container T or the liquid L therein is heated for five minutes within a temperature range of 80° C. to 100° C. As a result of these pressurizing/heat treatments, the collective substrate 3 is resin-sealed by the resin sheet 6 that is pressed and deformed through the sealed bag P. That is to say, while supplying a pressurizing fluid (compressed air) through the pressurizing fluid supply hole 12 into the pressurized container T so as to raise the pressure within the pressurized container T, the heat treatment is carried out so as to heat and temporarily soften the resin sheet 6 (temporary softening temperature: approximately 80° C.), thereby tightly adhering/attaching the resin sheet 6 onto the main face side of the SAW chips 2 and the collective substrate 3, which has already been chip mounted, to carry out the resin sealing.

Moreover, the resin sheet 6 may comprise a light curing type resin, and the sealed bag P and the liquid L accommodated within the pressurized container T may be made of materials that transmit a sufficient light wavelength (for example, ultraviolet light) for curing the light curing type resin material, to heat and cure the resin sheet 6 by irradiating light with this light wavelength thereon.

Here, Fluorinert is an appropriate liquid to be accommodated within the pressurized container T and to be used for resin-sealing. However, a liquid such as water or the like may be used as long as it is capable of maintaining its liquid state within the above mentioned pressure range and temperature range. Furthermore, the pressurized container T may be vacuumed prior to pressurizing so as to maintain the normal resin sealing state.

When accommodating the collective substrate 3 in the sealed bag P after the resin sheet 6 has been placed on the collective substrate on which the chips have already been mounted, the pressure of the pressurizing gas or liquid to be introduced into the pressurized container T is adjusted so that the hollow section S is formed on the active face of the SAW chip 2 (electronic element).

After the lid body 11 has been removed from the container main body 10, the sealed collective substrate 3 that has been resin-sealed and temporarily softened within the above mentioned temperature range is taken out together with the sealed bag P, and then a final curing is carried out (at approximately 150° C.). Then the resin-sealed collective substrate 3 is taken out of the sealed bag P and is subsequently transported to the next processing step.

What is claimed is:

1. A method of manufacturing electronic components on which electronic elements are mounted by face down bonding on wiring electrodes formed on a main face of a collective substrate, comprising the steps of:
placing a resin sheet on the main face of said collective substrate, on which said electronic elements have been mounted;
accommodating said collective substrate, on which said electronic elements have been mounted, in a flexible and sealed bag, and then seal-closing said sealed bag;
submerging said accommodating bag into a pressurized container filled with a liquid, and then sealing off said pressurized container;
supplying a pressurizing fluid into said pressurized container, raising the pressure within said pressurized container, carrying out heat application to heat-cure said resin sheet, and thereby tightly adhering said resin sheet onto the main face side of said electronic elements and said collective substrate, on which said electronic elements have been mounted so as to resin-seal said collective substrate;
taking out said sealed bag from said pressurized container; and
taking out the resin-sealed collective substrate, on which said electronic elements have been mounted, from said sealed bag.

2. A method of manufacturing electronic components according to claim 1, wherein said resin sheet is made of a heat curing type resin, and as a result of said pressurized container or the fluid accommodated within said pressurized container being heated by said heat application curing, said resin sheet is heat cured on said collective substrate, on which said electronic elements have been mounted, while, within said pressurized container, said sealed bag is pressed against and kept being tightly adhered onto said collective substrate on which said electronic elements have been mounted.

3. A method of manufacturing electronic components according to claim 1, wherein said resin sheet is made of a light curing type resin and said sealed bag and said fluid accommodated within said pressurized container are made of materials that transmit a sufficient light wavelength for curing said light curing type resin material, and said resin sheet is heat cured by irradiating light of said light wavelength.

4. A method of manufacturing electronic components according to claim 1, wherein said curing is such that said resin sheet is temporarily cured while it is being tightly adhered onto said collective substrate, on which said electronic elements have been mounted, and it is further cured after the resin-sealed collective substrate, on which said electronic elements have been mounted, has been taken out of said sealed bag.

5. A method of manufacturing electronic components according to claim 1, wherein said curing is carried out within said sealed bag that is submerged in a liquid or gas filling up said pressurized container.

6. A method of manufacturing electronic components according to claim 1, wherein when accommodating said collective substrate on which said electronic elements have been mounted, inside said sealed bag after said resin sheet has been placed on said collective substrate, the pressure of the pressurizing gas or liquid to be introduced into said pressurized container is adjusted so that a hollow section is formed on an active face of said electronic element.

7. A method of manufacturing electronic components according to claim 1, wherein when accommodating said collective substrate on which said electronic elements have been mounted, inside said sealed bag, said sealed bag is seal-closed after the interior of said sealed bag has been depressurized and degassed.

8. A method of manufacturing electronic components according to claim 1, wherein said electronic elements are piezoelectric elements such as surface acoustic elements, piezoelectric membrane filters, crystal oscillators, FBAR, and MEMS.

9. A method of manufacturing electronic components according to claim 1, wherein a flat plate is disposed in between said resin sheet and an inner face of said sealed bag.

10. A method of manufacturing electronic components according to claim 8, wherein said flat plate is made of a material harder than that of said resin sheet.

11. A method of manufacturing electronic components according to claim 1, wherein there is included a step of cutting said resin-sealed collective substrate, which has been taken out, into individual pieces.

12. An electronic component manufactured by a manufacturing method according to claim 1.
